(19) United States
(12) Patent Application Publication
(10) Pub. No.: US 2014/0087944 A1
(43) Pub. Date: Mar. 27, 2014

(54) COMPOSITIONS AND METHODS FOR ENHANCING PLANT GROWTH

(71) Applicant: NOVOZYMES BIOAG A/S, Bagsvaerd (DK)

(72) Inventors: Ahsan Habib, Roanoke, VA (US); Yaowei Kang, Christiansburg, VA (US); Shawn Semones, Salem, VA (US); Laura Blankenship, Roanoke, VA (US)

(73) Assignee: NOVOZYMES BIOAG A/S, Bagsvaerd (DK)

(21) Appl. No.: 14/037,957

(22) Filed: Sep. 26, 2013

Related U.S. Application Data
(60) Provisional application No. 61/706,494, filed on Sep. 27, 2012.

(51) Int. Cl. A01N 43/16

(52) U.S. Cl. CPC A01N 43/16
USPC 504/100; 504/292; 504/140; 504/117

(57) ABSTRACT

Described herein are compositions comprising one or more gluconolactones for enhancing plant growth and methods for treating plants, plant parts, or soils with one or more gluconolactones for enhancing plant growth.

### CROSS-REFERENCE TO RELATED APPLICATIONS

This application claims priority or the benefit under 35 U.S.C. 119 of U.S. provisional application No. 61/706,494 filed Sep. 27, 2012, the contents of which are fully incorporated herein by reference.

### FIELD OF THE INVENTION

Compositions comprising one or more gluconolactones and methods of using the compositions to enhance plant growth.

### BACKGROUND OF THE INVENTION

Lactones are cyclic esters characterized by a closed ring consisting of two or more carbon atoms, a single oxygen atom, and a ketone group adjacent to the oxygen atom. Lactone types include α-, β-, γ-, and δ-lactones with the prefixes indicating the size of the lactone ring (i.e., α-lactones have a 3-membered ring, β-lactones have a 4-membered ring, γ-lactones have a 5-membered ring, and δ-lactones have a 6 membered ring, etc.). The α- and β-lactones exist but are uncommon. For example, β-lactones can only be made using special methods and α-lactones are generally detected as transient species in mass spectrometry experiments.

Far and away, the γ- and δ-lactones, are the most common. Diketene and β-propanolactone are used in the synthesis of acetoacetic acid derivatives and β-substituted propanoic (propionic) acids, respectively, pentadecanolide and ambrettolide are used as perfume ingredients. Other lactones include vitamin C and the antibiotics methymycin, erythromycin, and carbomycin.

Certain lactones have been recognized as potentially useful in the agricultural industry. For example, some lactones have been recognized to regulate plant growth.

Kakisawa, H., et al. (1973). Biosynthesis of a C₁₆-Terpenoid Lactone, a Plant Growth Regulator. J.C.S. Chem. Comm. 20: 802-803 (discloses terpenoid lactones as a plant growth regulator).

Yonema, K., et al. Strigolactones as new plant growth regulator. The publication can be accessed on the world wide web at niaes.affrc.go.jp/marco/marco2009/english/W3-04_Yoneyama_Koichi.pdf;

U.S. Pat. App. No.: 2004/0209778 (discloses strigolactones as a new plant growth regulator).

U.S. Pat. App. No.: 2004/0209778 discloses a lactone derivative which exhibits excellent rooting activity and a plant growth regulator containing the derivative as an active ingredient.

Fung, S. & Siddall, J. (1980). Steroselective synthesis of brassinolide: a plant growth promoting steroidal lactone. J. Am. Chem. Soc. 102(21): 6580-6581, discloses brassinolide, a steroidal lactone, to promote plant growth.

A need remains, however, for compositions and methods for improving plant growth.

### SUMMARY OF THE INVENTION

Described herein are compositions comprising one or more gluconolactones. The inventors have found that gluconolactones can promote plant growth. It was further discovered that gluconolactones provide a synergistic effect for plant growth when they are combined with certain other plant signal molecules capable of promoting plant growth.

In one embodiment, the compositions described herein comprise a carrier and one or more gluconolactones. The gluconolactones include isomers, salts, or solvates thereof, as described herein.

In another embodiment, the composition comprises one or more gluconolactones, a carrier, and one or more agriculturally beneficial ingredients, such as one or more biologically active ingredients, one or more micronutrients, one or more biostimulants, one or more preservatives, one or more polymers, one or more wetting agents, one or more surfactants, one or more herbicides, one or more fungicides, one or more insecticides, or combinations thereof.

In one embodiment, the composition described herein comprises one or more gluconolactones, a carrier, and one or more biologically active ingredients. Biologically active ingredients may include one or more plant signal molecules. In a specific embodiment, the one or more biologically active ingredients may include one or more lipo-chitooligosaccharides (LCOs), one or more chitooligosaccharides (COs), one or more chitinous compounds, one or more flavonoids and derivatives thereof, one or more non-flavonoid nod gene inducers and derivatives thereof, one or more karrikins and derivatives thereof, or any signal molecule combination thereof.

Further described herein is a method for enhancing the growth of a plant or plant part comprising contacting a plant or plant part with one or more gluconolactones for enhancing plant growth. The gluconolactones include isomers, salts, or solvates thereof, as described herein. The method may further comprise subjecting the plant or plant part to one or more agriculturally beneficial ingredients, applied simultaneously or sequentially with the one or more gluconolactones. The one or more agriculturally beneficial ingredients can include one or more biologically active ingredients, one or more micronutrients, one or more biostimulants, or combinations thereof. In one embodiment, the method further comprises subjecting the plant or plant part to one or more biologically active ingredients. Biologically active ingredients may one or more plant signal molecules. In a specific embodiment, the one or more biologically active ingredients may include one or more LCOs, one or more chitinous compounds, one or more COs, one or more flavonoids and derivatives thereof, one or more non-flavonoid nod gene inducers and derivatives thereof, one or more karrikins and derivatives thereof, or any signal molecule combination thereof.

In a specific embodiment described herein, is a method for enhancing the growth of a plant or plant part comprising contacting seed with one or more gluconolactones for enhancing plant growth. The gluconolactones include isomers, salts, or solvates thereof, as described herein. The method may further comprise subjecting the seed to one or more agriculturally beneficial ingredients, applied simultaneously or sequentially with the one or more gluconolactones.

Further still, a method for enhancing the growth of a plant or plant part is described, comprising treating a soil with one or more gluconolactones or salts thereof. Plant(s) or plant part(s) in the treated soil will then contact the gluconolactones. The treating step may occur at any time before, during, or after planting, or before or during growing the plant or plant part (e.g., treating the soil before the plant or plant part begins to grow, treating the soil during the growth of the plant or plant part, etc.). The gluconolactones include isomers, salts, or solvates thereof, as described herein. The growing step may further comprise growing the plant in a soil with one or more agriculturally beneficial ingredients. The one or more agriculturally beneficial ingredients can include one or more biologically active ingredients, one or more micronutrients, one or more biostimulants, or combinations thereof. In one embodiment, the growing step further comprises growing the plant in a soil with one or more biologically active ingredients. Biologically active ingredients may include one or more plant signal molecules. In a specific embodiment, the one or more biologically active ingredients may include one or more LCOs, one or more chitinous compounds, one or more COs, one or more flavonoids and derivatives thereof, one or more non-flavonoid nod gene inducers and derivatives thereof, one or more karrikins and derivatives thereof, or any signal molecule combination thereof.

Finally, a seed coated with one or more gluconolactones is described herein. Embodiments include seeds coated with any of the compositions described herein.

### DETAILED DESCRIPTION OF THE INVENTION

The disclosed embodiments relate to compositions and methods for enhancing plant growth.

### Definitions

As used herein, the singular forms “a”, “an” and “the” are intended to include the plural forms as well, unless the context clearly indicates otherwise.

As used herein, the term “agriculturally beneficial ingredient(s)” is intended to mean any agent or combination of agents capable of causing or providing a beneficial and/or useful effect in agriculture.

As used herein, “biologically active ingredient(s)” is intended to mean biologically active ingredients (e.g., plant signal molecules, other microorganisms, etc.) other than the one or more gluconolactones described herein.

As used herein, the term “gluconolactone(s)” is intended to include all isomer, solvate, hydrate, polymorphic, crystalline form, non-crystalline form, and salt variations of the following gluconolactone structure:

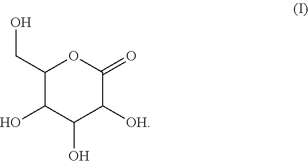 [SMILES: O=C1OC(CO)C(O)C(O)C1O]

As used herein, the term “isomer(s)” is intended to include all stereoisomers of the compounds and/or molecules referred to herein (e.g., gluconolactones, LCOs, COs, chitinous compounds, flavonoids, jasmonic acid or derivatives thereof, linoleic acid or derivatives thereof, linolenic acid or derivatives thereof, kerrikins, etc.), including enantiomers, diastereomers, as well as all conformers, rotamers, and tautomers, unless otherwise indicated. The compounds and/or molecules disclosed herein include all enantiomers in either substantially pure levorotatory or dextrorotatory form, or in a racemic mixture, or in any ratio of enantiomers. Where embodiments disclose a (D)-enantiomer, that embodiment also includes the (L)-enantiomer; where embodiments disclose a (L)-enantiomer, that embodiment also includes the (D)-enantiomer. Where embodiments disclose a (+)-enantiomer, that embodiment also includes the (−)-enantiomer; where embodiments disclose a (−)-enantiomer, that embodiment also includes the (+)-enantiomer. Where embodiments disclose a (S)-enantiomer, that embodiment also includes the (R)-enantiomer; where embodiments disclose a (R)-enantiomer, that embodiment also includes the (S)-enantiomer. Embodiments are intended to include any diastereomers of the compounds and/or molecules referred to herein in diastereomerically pure form and in the form of mixtures in all ratios. Unless stereochemistry is explicitly indicated in a chemical structure or chemical name, the chemical structure or chemical name is intended to embrace all possible stereoisomers, conformers, rotamers, and tautomers of compounds and/or molecules depicted.

As used herein, the terms “effective amount”, “effective concentration”, or “effective dosage” is intended to mean the amount, concentration, or dosage of the one or more gluconolactones sufficient to cause enhanced plant growth. The actual effective dosage in absolute value depends on factors including, but not limited to, the size (e.g., the area, the total acreage, etc.) of the land for application with the one or more gluconolactones, synergistic or antagonistic interactions between the other active or inert ingredients which may increase or reduce the growth enhancing effects of the one or more gluconolactones, and the stability of the one or more gluconolactones in compositions and/or as seed treatments. The “effective amount”, “effective concentration”, or “effective dosage” of the one or more gluconolactones may be determined, e.g., by a routine dose response experiment.

As used herein, the term “carrier” is intended to refer to an “agronomically acceptable carrier.” An “agronomically acceptable carrier” is intended to refer to any material which can be used to deliver the actives (e.g., gluconolactones described herein, agriculturally beneficial ingredient(s), biologically active ingredient(s), etc.) to a plant, a plant part (e.g., a seed), or a soil, and preferably which carrier can be added (to the plant, plant part (e.g., seed), or soil) without having an adverse effect on plant growth, soil structure, soil drainage or the like.

As used herein, the term “soil-compatible carrier” is intended to refer to any material which can be added to a soil without causing/having an adverse effect on plant growth, soil structure, soil drainage, or the like.

As used herein, the term “seed-compatible carrier” is intended to refer to any material which can be added to a seed without causing/having an adverse effect on the seed, the plant that grows from the seed, seed germination, or the like.

As used herein, the term “foliar-compatible carrier” is intended to refer to any material which can be added to a plant or plant part without causing/having an adverse effect on the plant, plant part, plant growth, plant health, or the like.

As used herein, the term “micronutrient(s)” is intended to refer to nutrients which are needed for plant growth, plant health, and/or plant development.

As used herein, the term “biostimulant(s)” is intended to refer to any agent or combination of agents capable of enhancing metabolic or physiological processes within plants and soils.

As used herein, the term “herbicide(s)” is intended to refer to any agent or combination of agents capable of killing weeds and/or inhibiting the growth of weeds (the inhibition being reversible under certain conditions).

As used herein, the term “fungicide(s)” is intended to refer to any agent or combination of agents capable of killing fungi and/or inhibiting fungal growth.

As used herein, the term “insecticide(s)” is intended to refer to any agent or combination of agents capable of killing one or more insects and/or inhibiting the growth of one or more insects.

As used herein, term “enhanced plant growth” is intended to refer to increased plant yield (e.g., increased biomass, increased fruit number, or a combination thereof as measured by bushels per acre), increased root number, increased root mass, increased root volume, increased leaf area, increased plant stand, increased plant vigor, or combinations thereof.

As used herein, the terms “plant(s)” and “plant part(s)” are intended to refer to all plants and plant populations such as desired and undesired wild plants or crop plants (including naturally occurring crop plants). Crop plants can be plants, which can be obtained by conventional plant breeding and optimization methods or by biotechnological and genetic engineering methods or by combinations of these methods, including the transgenic plants and including the plant cultivars protectable or not protectable by plant breeders' rights. Plant parts are to be understood as meaning all parts and organs of plants above and below the ground, such as shoot, leaf, flower and root, examples which may be mentioned being leaves, needles, stalks, stems, flowers, fruit bodies, fruits, seeds, roots, tubers and rhizomes. The plant parts also include harvested material and vegetative and generative propagation material (e.g., cuttings, tubers, rhizomes, off-shoots and seeds, etc.).

As used herein, the term “inoculum” is intended to mean any form of microbial cells, or spores, which is capable of propagating on or in the soil when the conditions of temperature, moisture, etc., are favorable for microbial growth.

As used herein, the term “nitrogen fixing organism(s)” is intended to refer to any organism capable of converting atmospheric nitrogen (N₂) into ammonia (NH₃).

As used herein, the term “phosphate solubilizing organism” is intended to refer to any organism capable of converting insoluble phosphate into a soluble phosphate form.

As used herein, the terms “spore” has its normal meaning which is well known and understood by those of skill in the art. As used herein, the term spore refers to a microorganism in its dormant, protected state.

As used herein, the term “source” of a particular element is intended to mean a compound of that element which, at least in the soil conditions under consideration, does not make the element fully available for plant uptake.

### Compositions

The compositions disclosed comprise a carrier and one or more gluconolactones described herein. In certain embodiments, the composition may be in the form of a liquid, a gel, a slurry, a solid, or a powder (wettable powder or dry powder). In another embodiment, the composition may be in the form of a seed coating. Compositions in liquid, slurry, or powder (e.g., wettable powder) form may be suitable for coating seeds. When used to coat seeds, the composition may be applied to the seeds and allowed to dry. In embodiments wherein the composition is a powder (e.g., a wettable powder), a liquid, such as water, may need to be added to the powder before application to a seed.

### Gluconolactones:

As disclosed throughout, the compositions described herein comprise one or more gluconolactones. The one or more gluconolactones may be a natural gluconolactone (i.e., not synthetically produced), a synthetic gluconolactone (e.g., a chemically synthesized gluconolactone) or a combination thereof.

In one embodiment, the one or more gluconolactones have the molecular formula C₆H₁₀O₆ and a molar mass of about 178.14 g mol⁻¹. In another embodiment, the one or more gluconolactones may include gluconolactones having the structure (I):

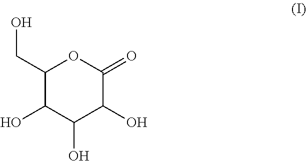 [SMILES: O=C1OC(CO)C(O)C(O)C1O]

and isomers, salts, and solvates thereof.

In another embodiment, the one or more gluconolactones may include gluconolactones having the structure (I-A):

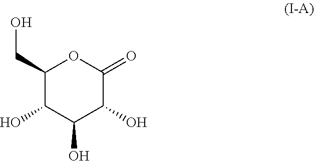 [SMILES: O=C1O[C@H](CO)[C@@H](O)[C@H](O)[C@H]1O]

and salts and solvates thereof.

In another embodiment, the one or more gluconolactones may include gluconolactones having the structure (I-B):

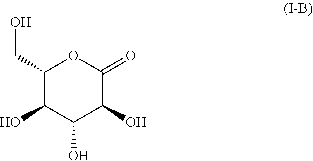 [SMILES: O=C1O[C@@H](CO)[C@H](O)[C@@H](O)[C@@H]1O]

and salts and solvates thereof.

In another embodiment, the one or more gluconolactones may include gluconolactones having the structure (I-C):

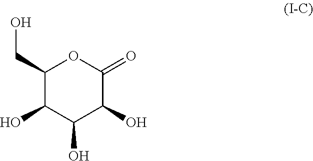 [SMILES: O=C1O[C@H](CO)[C@H](O)[C@H](O)[C@@H]1O]

and salts and solvates thereof.

In another embodiment, the one or more gluconolactones may include gluconolactones having the structure (I-D):

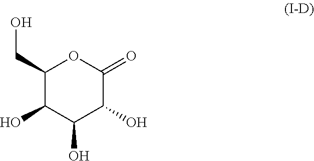 [SMILES: O=C1O[C@H](CO)[C@H](O)[C@H](O)[C@H]1O]

and salts and solvates thereof.

In another embodiment, the one or more gluconolactones may include gluconolactones having the structure (I-E):

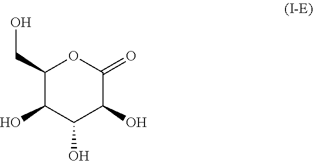 [SMILES: O=C1O[C@H](CO)[C@H](O)[C@@H](O)[C@@H]1O]

and salts and solvates thereof.

In another embodiment, the one or more gluconolactones may include gluconolactones having the structure (I-F):

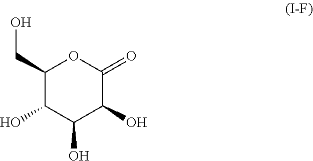 [SMILES: O=C1O[C@H](CO)[C@@H](O)[C@H](O)[C@@H]1O]

and salts and solvates thereof.

In another embodiment, the one or more gluconolactones may include gluconolactones having the structure (I-G):

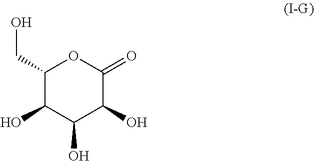 [SMILES: O=C1O[C@@H](CO)[C@H](O)[C@H](O)[C@@H]1O]

and salts and solvates thereof.

In another embodiment, the one or more gluconolactones may include gluconolactones having the structure (I-H):

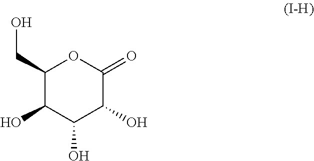 [SMILES: O=C1O[C@H](CO)[C@H](O)[C@@H](O)[C@H]1O]

and salts and solvates thereof.

In another embodiment, the one or more gluconolactones may include gluconolactones having the structure (I-I):

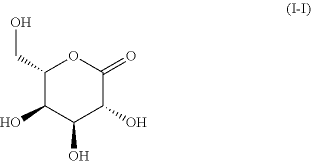 [SMILES: O=C1O[C@@H](CO)[C@H](O)[C@H](O)[C@H]1O]

and salts and solvates thereof.

In another embodiment, the one or more gluconolactones may include gluconolactones having the structure (I-J):

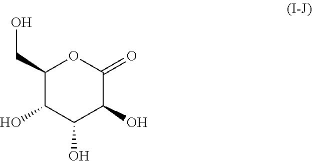 [SMILES: O=C1O[C@H](CO)[C@@H](O)[C@@H](O)[C@@H]1O]

and salts and solvates thereof.

In another embodiment, the one or more gluconolactones may include gluconolactones having the structure (I-K):

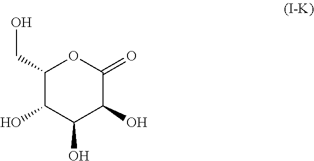 [SMILES: O=C1O[C@@H](CO)[C@@H](O)[C@H](O)[C@@H]1O]

and salts and solvates thereof.

In another embodiment, the one or more gluconolactones may include gluconolactones having the structure (I-L):

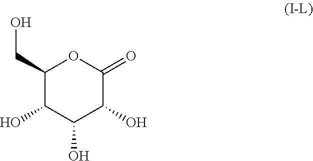 [SMILES: O=C1O[C@H](CO)[C@@H](O)[C@@H](O)[C@H]1O]

and salts and solvates thereof.

In another embodiment, the one or more gluconolactones may include gluconolactones having the structure (I-M):

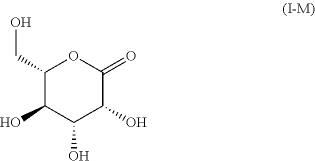 [SMILES: O=C1O[C@@H](CO)[C@H](O)[C@@H](O)[C@H]1O]

and salts and solvates thereof.

In another embodiment, the one or more gluconolactones may include gluconolactones having the structure (I-N):

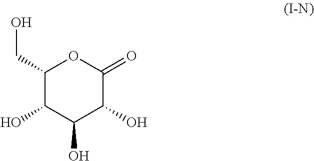 [SMILES: O=C1O[C@@H](CO)[C@@H](O)[C@H](O)[C@H]1O]

and salts and solvates thereof.

In another embodiment, the one or more gluconolactones may include gluconolactones having the structure (I-O):

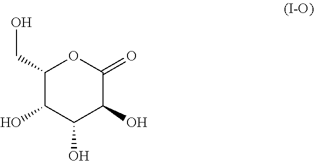 [SMILES: O=C1O[C@@H](CO)[C@@H](O)[C@@H](O)[C@@H]1O]

and salts and solvates thereof.

In another embodiment, the one or more gluconolactones may include gluconolactones having the structure (I-P):

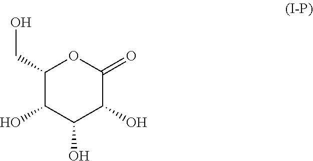 [SMILES: O=C1O[C@@H](CO)[C@@H](O)[C@@H](O)[C@H]1O]

and salts and solvates thereof.

In one embodiment, the one or more gluconolactones used in the compositions described herein may be at least two of the above gluconolactones (i.e., at least two of I-A, I-B, I-C, I-D, I-E, I-F, I-G, I-H, I-I, 1-J, I-K, I-L, I-M, I-N, I-O, and I-P), at least three of the above gluconolactones, at least four of the above gluconolactones, at least five of the above gluconolactones, at least six of the above gluconolactones, at least seven of the above gluconolactones, at least eight of the above gluconolactones, at least nine of the above gluconolactones, at least ten of the above gluconolactones, at least eleven of the above gluconolactones, at least twelve of the above gluconolactones, at least thirteen of the above gluconolactones, at least fourteen of the above gluconolactones, at least fifteen of the above gluconolactones, at least sixteen of the above gluconolactones, up to and including all of the above gluconolactones, including salts and solvates thereof.

### Carriers:

The carriers described herein will allow the one or more gluconolactone(s) to remain efficacious (e.g., capable of increasing plant growth). Non-limiting examples of carriers described herein include liquids, gels, slurries, or solids (including wettable powders or dry powders). The selection of the carrier material will depend on the intended application. The carrier may, for example, be a soil-compatible carrier, a seed-compatible carrier and/or a foliar-compatible carrier. In an embodiment, the carrier is a soil compatible carrier. In another embodiment, the carrier is a seed-compatible carrier. In yet another embodiment, the carrier is a foliar-compatible carrier.

In one embodiment, the carrier is a liquid carrier. Non-limiting examples of liquids useful as carriers for the compositions disclosed herein include water, an aqueous solution, or a non-aqueous solution. In one embodiment, the carrier is water. In another embodiment the carrier is an aqueous solution. In another embodiment, the carrier is a non-aqueous solution. If a liquid carrier is used, the liquid (e.g., water) carrier may further include growth media to culture one or more microbial strains used in the compositions described. Non-limiting examples of suitable growth media for microbial strains include YEM media, mannitol yeast extract, glycerol yeast extract, Czapek-Dox medium, potato dextrose broth, or any media known to those skilled in the art to be compatible with, and/or provide growth nutrients to microbial strain which may be included to the compositions described herein.

Gluconolactone is readily water soluble, and in a particular embodiment, the carrier is water. In a more particular embodiment, the one or more gluconolactones are added to the water carrier at a concentration of 0.5-500.0 mg/L. In another embodiment, the one or more gluconolactones are added to the water carrier at a concentration of 1.0-100.0 mg/L. In still another embodiment, the one or more gluconolactones are added to the water carrier at a concentration of 500.0 mg/l. In still another embodiment, the one or more gluconolactones are added to the water carrier at a concentration of 400.0 mg/l. In still another embodiment, the one or more gluconolactones are added to the water carrier at a concentration of 300.0 mg/l. In still another embodiment, the one or more gluconolactones are added to the water carrier at a concentration of 250.0 mg/l. In still another embodiment, the one or more gluconolactones are added to the water carrier at a concentration of 200.0 mg/l. In still another embodiment, the one or more gluconolactones are added to the water carrier at a concentration of 175.0 mg/l. In still another embodiment, the one or more gluconolactones are added to the water carrier at a concentration of 150.0 mg/l. In still another embodiment, the one or more gluconolactones are added to the water carrier at a concentration of 125.0 mg/l. In still another embodiment, the one or more gluconolactones are added to the water carrier at a concentration of 100.0 mg/l. In still another embodiment, the one or more gluconolactones are added to the water carrier at a concentration of 75.0 mg/l. In still another embodiment, the one or more gluconolactones are added to the water carrier at a concentration of 50.0 mg/l. In still another embodiment, the one or more gluconolactones are added to the water carrier at a concentration of 25.0 mg/l. In still another embodiment, the one or more gluconolactones are added to the water carrier at a concentration of 15.0 mg/l. In still another embodiment, the one or more gluconolactones are added to the water carrier at a concentration of 12.5 mg/l. In still another embodiment, the one or more gluconolactones are added to the water carrier at a concentration of 10.0 mg/l. In still another embodiment, the one or more gluconolactones are added to the water carrier at a concentration of 7.5 mg/l. In still another embodiment, the one or more gluconolactones are added to the water carrier at a concentration of 5.0 mg/l. In still another embodiment, the one or more gluconolactones are added to the water carrier at a concentration of 2.5 mg/l. In still another embodiment, the one or more gluconolactones are added to the water carrier at a concentration of 2.0 mg/l. In still another embodiment, the one or more gluconolactones are added to the water carrier at a concentration of 1.75 mg/l. In still another embodiment, the one or more gluconolactones are added to the water carrier at a concentration of 1.50 mg/l. In still another embodiment, the one or more gluconolactones are added to the water carrier at a concentration of 1.25 mg/l. In still another embodiment, the one or more gluconolactones are added to the water carrier at a concentration of 1.0 mg/l. In still another embodiment, the one or more gluconolactones are added to the water carrier at a concentration of 0.75 mg/l. In still yet another embodiment, the one or more gluconolactones are added to the water carrier at a concentration of 0.5 mg/L.

### Agriculturally Beneficial Ingredients:

The compositions disclosed herein may comprise one or more agriculturally beneficial ingredients. Non-limiting examples of agriculturally beneficial ingredients include one or more biologically active ingredients, micronutrients, biostimulants, preservatives, polymers, wetting agents, surfactants, herbicides, fungicides, insecticides, or combinations thereof.

Biologically Active Ingredient(s):

The compositions described herein may optionally include one or more biologically active ingredients as described herein, other than the one or more gluconolactones described herein. Non-limiting examples of biologically active ingredients include plant signal molecules (e.g., lipo-chitooligosaccharides (LCO), chitooligosaccharides (CO), chitinous compounds, flavonoids, jasmonic acid or derivatives thereof, linoleic acid or derivatives thereof, linolenic acid or derivatives thereof, karrikins, etc.) and beneficial microorganisms (e.g., Rhizobium spp., Bradyrhizobium spp., Sinorhizobium spp., Azorhizobium spp., Glomus spp., Gigaspora spp., Hymenoscyphous spp., Oidiodendron spp., Laccaria spp., Pisolithus spp., Rhizopogon spp., Scleroderma spp., Rhizoctonia spp., Acinetobacter spp., Arthrobacter spp, Arthrobotrys spp., Aspergillus spp., Azospirillum spp, Bacillus spp, Burkholderia spp., Candida spp., Chryseomonas spp., Enterobacter spp., Eupenicillium spp., Exiguobacterium spp., Klebsiella spp., Kluyvera spp., Microbacterium spp., Mucor spp., Paecilomyces spp., Paenibacillus spp., Penicillium spp., Pseudomonas spp., Serratia spp., Stenotrophomonas spp., Streptomyces spp., Streptosporangium spp., Swaminathania spp., Thiobacillus spp., Torulospora spp., Vibrio spp., Xanthobacter spp., Xanthomonas spp., etc.).

Plant Signal Molecule(s):

In an embodiment, the compositions described herein include one or more plant signal molecules. In one embodiment, the one or more plant signal molecules are one or more LCOs. In another embodiment, the one or more plant signal molecules are one or more COs. In still another embodiment, the one or more plant signal molecules are one or more chitinous compounds. In yet another embodiment, the one or more plant signal molecules are one or more flavonoids or derivatives thereof. In still yet another embodiment, the one or more plant signal molecules are one or more non-flavonoid nod gene inducers (e.g., jasmonic acid, linoleic acid, linolenic acid, and derivatives thereof). In still yet another embodiment, the one or more plant signal molecules are one or more karrikins or derivatives thereof. In still another embodiment, the one or more plant signal molecules are one or more LCOs, one or more COs, one or more chitinous compounds, one or more flavonoids and derivatives thereof, one or more non-flavonoid nod gene inducers and derivatives thereof, one or more karrikins and derivatives thereof, or any signal molecule combination thereof.

LCOs:

Lipo-chitooligosaccharide compounds (LCOs), also known in the art as symbiotic Nod signals or Nod factors, consist of an oligosaccharide backbone of β-I,4-linked N-acetyl-D-glucosamine (“GlcNAc”) residues with an N-linked fatty acyl chain condensed at the non-reducing end. LCO's differ in the number of GlcNAc residues in the backbone, in the length and degree of saturation of the fatty acyl chain, and in the substitutions of reducing and non-reducing sugar residues. LCOs are intended to include all LCOs as well as isomers, salts, and solvates thereof. An example of an LCO is presented below as formula I:

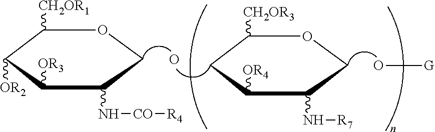

in which:

G is a hexosamine which can be substituted, for example, by an acetyl group on the nitrogen, a sulfate group, an acetyl group and/or an ether group on an oxygen,

R₁, R₂, R₃, R₅, R₆ and R₇, which may be identical or different, represent H, CH₃CO—, CₓH_{y}CO— where x is an integer between 0 and 17, and y is an integer between 1 and 35, or any other acyl group such as for example a carbamyl,

R₄ represents a mono-, di-, tri- and tetraunsaturated aliphatic chain containing at least 12 carbon atoms, and n is an integer between 1 and 4.

LCOs may be obtained (isolated and/or purified) from bacteria such as Rhizobia, e.g., Rhizobium spp., Bradyrhizobium spp., Sinorhizobium spp. and Azorhizobium spp. LCO structure is characteristic for each such bacterial species, and each strain may produce multiple LCO's with different structures. For example, specific LCOs from S. meliloti have also been described in U.S. Pat. No. 5,549,718 as having the formula II:

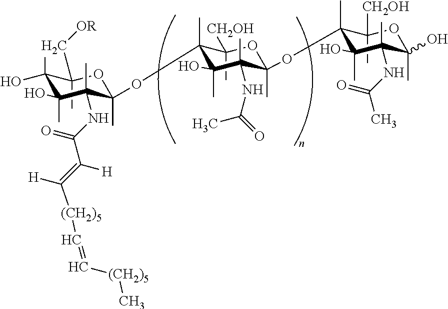

in which R represents H or CH₃CO— and n is equal to 2 or 3.

Even more specific LCOs include NodRM, NodRM-1, NodRM-3. When acetylated (the R═CH₃CO—), they become AcNodRM-1, and AcNodRM-3, respectively (U.S. Pat. No. 5,545,718).

LCOs from Bradyrhizobium japonicum are described in U.S. Pat. Nos. 5,175,149 and 5,321,011. Broadly, they are pentasaccharide phytohormones comprising methylfucose. A number of these B. japonicum-derived LCOs are described: BjNod-V (C_{18:1}); BjNod-V (A_{C}, C_{18:1}), BjNod-V (C_{16:1}); and BjNod-V (A_{C}, C_{16:0}), with “V” indicating the presence of five N-acetylglucosamines; “Ac” an acetylation; the number following the “C” indicating the number of carbons in the fatty acid side chain; and the number following the “:” the number of double bonds.

LCOs used in compositions of the invention may be obtained (i.e., isolated and/or purified) from bacterial strains that produce LCO's, such as strains of Azorhizobium, Bradyrhizobium (including B. japonicum), Mesorhizobium, Rhizobium (including R. leguminosarum), Sinorhizobium (including S. meliloti), and bacterial strains genetically engineered to produce LCO's.

Also encompassed by the present invention are compositions using LCOs obtained (i.e., isolated and/or purified) from a mycorrhizal fungus, such as fungi of the group Glomerocycota, e.g., Glomus intraradicus. The structures of representative LCOs obtained from these fungi are described in WO 2010/049751 and WO 2010/049751 (the LCOs described therein also referred to as “Myc factors”).

Further encompassed by compositions of the present invention is use of synthetic LCO compounds, such as those described in WO 2005/063784, and recombinant LCO's produced through genetic engineering. The basic, naturally occurring LCO structure may contain modifications or substitutions found in naturally occurring LCO's, such as those described in Spaink, Crit. Rev. Plant Sci. 54:257-288 (2000) and D'Haeze, et al., Glycobiology 12:79R-105R (2002). Precursor oligosaccharide molecules (COs, which as described below, are also useful as plant signal molecules in the present invention) for the construction of LCOs may also be synthesized by genetically engineered organisms, e.g., as in Samain, et al., Carb. Res. 302:35-42 (1997); Samain, et al., J. Biotechnol. 72:33-47 (1999).

LCO's may be utilized in various forms of purity and may be used alone or in the form of a culture of LCO-producing bacteria or fungi. Methods to provide substantially pure LCO's include simply removing the microbial cells from a mixture of LCOs and the microbe, or continuing to isolate and purify the LCO molecules through LCO solvent phase separation followed by HPLC chromatography as described, for example, in U.S. Pat. No. 5,549,718. Purification can be enhanced by repeated HPLC, and the purified LCO molecules can be freeze-dried for long-term storage.

COs:

Chitooligosaccharides (COs) are known in the art as β-1-4 linked N-actylglucosamine structures identified as chitin oligomers, also as N-acetylchitooligosaccharides. CO's have unique and different side chain decorations which make them different from chitin molecules [(C₈H₁₃NO₅)n, CAS No. 1398-61-4], and chitosan molecules [(C₅H₁₁NO₄)n, CAS No. 9012-76-4]. Representative literature describing the structure and production of COs is as follows: Van der Hoist, et al., Current Opinion in Structural Biology, 11:608-616 (2001); Robina, et al., Tetrahedron 58:521-530 (2002); Hanel, et al., Planta 232:787-806 (2010); Rouge, et al. Chapter 27, “The Molecular Immunology of Complex Carbohydrates” in Advances in Experimental Medicine and Biology, Springer Science; Wan, et al., Plant Cell 21:1053-69 (2009); PCT/F100/00803 (Sep. 21, 2000); and Demont-Caulet, et al., Plant Physiol. 120(1):83-92 (1999). The COs may be synthetic or recombinant. Methods for preparation of recombinant COs are known in the art. See, e.g., Samain, et al. (supra.); Cottaz, et al., Meth. Eng. 7(4):311-7 (2005) and Samain, et al., J. Biotechnol. 72:33-47 (1999). COs are intended to include isomers, salts, and solvates thereof.

Chitinous Compounds:

Chitins and chitosans, which are major components of the cell walls of fungi and the exoskeletons of insects and crustaceans, are also composed of GlcNAc residues. Chitinous compounds include chitin, (IUPAC: N-[5-[[3-acetylamino-4,5-dihydroxy-6-(hydroxymethyl)oxan-2yl]methoxymethyl]-2-[[5-acetylamino-4,6-dihydroxy-2-(hydroxymethyl)oxan-3-yl]methoxymethyl]-4-hydroxy-6-(hydroxymethyl)oxan-3-ys]ethanamide), chitosan, (IUPAC: 5-amino-6-[5-amino-6-[5-amino-4,6-dihydroxy-2(hydroxymethyl)oxan-3-yl]oxy-4-hydroxy-2-(hydroxymethyl)oxan-3-yl]oxy-2(hydroxymethyl)oxane-3,4-diol), and isomers, salts, and solvates thereof.

These compounds may be obtained commercially, e.g., from Sigma-Aldrich, or prepared from insects, crustacean shells, or fungal cell walls. Methods for the preparation of chitin and chitosan are known in the art, and have been described, for example, in U.S. Pat. No. 4,536,207 (preparation from crustacean shells), Pochanavanich, et al., Lett. Appl. Microbiol. 35:17-21 (2002) (preparation from fungal cell walls), and U.S. Pat. No. 5,965,545 (preparation from crab shells and hydrolysis of commercial chitosan). Deacetylated chitins and chitosans may be obtained that range from less than 35% to greater than 90% deacetylation, and cover a broad spectrum of molecular weights, e.g., low molecular weight chitosan oligomers of less than 15 kD and chitin oligomers of 0.5 to 2 kD; “practical grade” chitosan with a molecular weight of about 15 kD; and high molecular weight chitosan of up to 70 kD. Chitin and chitosan compositions formulated for seed treatment are also commercially available. Commercial products include, for example, ELEXA® (Plant Defense Boosters, Inc.) and BEYOND™ (Agrihouse, Inc.).

Flavonoids:

Flavonoids are phenolic compounds having the general structure of two aromatic rings connected by a three-carbon bridge. Flavonoids are produced by plants and have many functions, e.g., as beneficial signaling molecules, and as protection against insects, animals, fungi and bacteria. Classes of flavonoids include chalcones, anthocyanidins, coumarins, flavones, flavanols, flavonols, flavanones, and isoflavones. See, Jain, et al., J. Plant Biochem. & Biotechnol. 11:1-10 (2002); Shaw, et al., Environmental Microbiol. 11:1867-80 (2006).

Representative flavonoids that may be useful in compositions of the present invention include luteolin, apigenin, tangeritin, quercetin, kaempferol, myricetin, fisetin, isorhamnetin, pachypodol, rhamnazin, hesperetin, naringenin, formononetin, eriodictyol, homoeriodictyol, taxifolin, dihydroquercetin, dihydrokaempferol, genistein, daidzein, glycitein, catechin, gallocatechin, catechin 3-gallate, gallocatechin 3-gallate, epicatechin, epigallocatechin, epicatechin 3-gallate, epigallocatechin 3-gallate, cyaniding, delphinidin, malvidin, pelargonidin, peonidin, petunidin, or derivatives thereof. Flavonoid compounds are commercially available, e.g., from Natland International Corp., Research Triangle Park, N.C.; MP Biomedicals, Irvine, Calif.; LC Laboratories, Woburn Mass. Flavonoid compounds may be isolated from plants or seeds, e.g., as described in U.S. Pat. Nos. 5,702,752; 5,990,291; and 6,146,668. Flavonoid compounds may also be produced by genetically engineered organisms, such as yeast, as described in Ralston, et al., Plant Physiology 137:1375-88 (2005). Flavonoid compounds are intended to include all flavonoid compounds as well as isomers, salts, and solvates thereof.

Non-Flavonoid Nod-Gene Inducer(s):

Jasmonic acid (JA, [1R-[1α,2β(Z)]]-3-oxo-2-(pentenyl)cyclopentaneacetic acid) and its derivatives, linoleic acid ((Z,Z)-9,12-Octadecadienoic acid) and its derivatives, and linolenic acid ((Z,Z,Z)-9,12,15-octadecatrienoic acid) and its derivatives, may also be used in the compositions described herein. Non-flavonoid nod-gene inducers are intended to include not only the non-flavonoid nod-gene inducers described herein, but isomers, salts, and solvates thereof.

Jasmonic acid and its methyl ester, methyl jasmonate (MeJA), collectively known as jasmonates, are octadecanoid-based compounds that occur naturally in plants. Jasmonic acid is produced by the roots of wheat seedlings, and by fungal microorganisms such as Botryodiplodia theobromae and Gibbrella fujikuroi, yeast (Saccharomyces cerevisiae), and pathogenic and non-pathogenic strains of Escherichia coli. Linoleic acid and linolenic acid are produced in the course of the biosynthesis of jasmonic acid. Jasmonates, linoleic acid and linoleic acid (and their derivatives) are reported to be inducers of nod gene expression or LCO production by rhizobacteria. See, e.g., Mabood, Fazli, Jasmonates induce the expression of nod genes in Bradyrhizobium japonicum, May 17, 2001; and Mabood, Fazli, “Linoleic and linolenic acid induce the expression of nod genes in Bradyrhizobium japonicum,” USDA 3, May 17, 2001.

Useful derivatives of linoleic acid, linolenic acid, and jasmonic acid that may be useful in compositions of the present invention include esters, amides, glycosides and salts. Representative esters are compounds in which the carboxyl group of linoleic acid, linolenic acid, or jasmonic acid has been replaced with a—COR group, where R is an —OR¹ group, in which R¹ is: an alkyl group, such as a C₁-C₈ unbranched or branched alkyl group, e.g., a methyl, ethyl or propyl group; an alkenyl group, such as a C₂-C₈ unbranched or branched alkenyl group; an alkynyl group, such as a C₂-C₈ unbranched or branched alkynyl group; an aryl group having, for example, 6 to 10 carbon atoms; or a heteroaryl group having, for example, 4 to 9 carbon atoms, wherein the heteroatoms in the heteroaryl group can be, for example, N, O, P, or S. Representative amides are compounds in which the carboxyl group of linoleic acid, linolenic acid, or jasmonic acid has been replaced with a—COR group, where R is an NR²R³ group, in which R² and R³ are independently: hydrogen; an alkyl group, such as a C₁-C₈ unbranched or branched alkyl group, e.g., a methyl, ethyl or propyl group; an alkenyl group, such as a C₂-C₈ unbranched or branched alkenyl group; an alkynyl group, such as a C₂-C₈ unbranched or branched alkynyl group; an aryl group having, for example, 6 to 10 carbon atoms; or a heteroaryl group having, for example, 4 to 9 carbon atoms, wherein the heteroatoms in the heteroaryl group can be, for example, N, O, P, or S. Esters may be prepared by known methods, such as acid-catalyzed nucleophilic addition, wherein the carboxylic acid is reacted with an alcohol in the presence of a catalytic amount of a mineral acid. Amides may also be prepared by known methods, such as by reacting the carboxylic acid with the appropriate amine in the presence of a coupling agent such as dicyclohexyl carbodiimide (DCC), under neutral conditions. Suitable salts of linoleic acid, linolenic acid, and jasmonic acid include e.g., base addition salts. The bases that may be used as reagents to prepare metabolically acceptable base salts of these compounds include those derived from cations such as alkali metal cations (e.g., potassium and sodium) and alkaline earth metal cations (e.g., calcium and magnesium). These salts may be readily prepared by mixing together a solution of linoleic acid, linolenic acid, or jasmonic acid with a solution of the base. The salt may be precipitated from solution and be collected by filtration or may be recovered by other means such as by evaporation of the solvent.

Karrikin(s):

Karrikins are vinylogous 4H-pyrones e.g., 2H-furo[2,3-c]pyran-2-ones including derivatives and analogues thereof. It is intended that the karrikins include isomers, salts, and solvates thereof. Examples of these compounds are represented by the following structure:

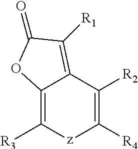

wherein; Z is O, S or NR₅; R₁, R₂, R₃, and R₄ are each independently H, alkyl, alkenyl, alkynyl, phenyl, benzyl, hydroxy, hydroxyalkyl, alkoxy, phenyloxy, benzyloxy, CN, COR₆, COOR═, halogen, NR₆R₇, or NO₂; and R₅, R₆, and R₇ are each independently H, alkyl or alkenyl, or a biologically acceptable salt thereof. Examples of biologically acceptable salts of these compounds may include acid addition salts formed with biologically acceptable acids, examples of which include hydrochloride, hydrobromide, sulphate or bisulphate, phosphate or hydrogen phosphate, acetate, benzoate, succinate, fumarate, maleate, lactate, citrate, tartrate, gluconate; methanesulphonate, benzenesulphonate and p-toluenesulphonic acid. Additional biologically acceptable metal salts may include alkali metal salts, with bases, examples of which include the sodium and potassium salts. Examples of compounds embraced by the structure and which may be suitable for use in the present invention include the following: 3-methyl-2H-furo[2,3-c]pyran-2-one (where R₁═CH₃, R₂, R₃, R₄═H), 2H-furo[2,3-c]pyran-2-one (where R₁, R₂, R₃, R4=H), 7-methyl-2H-furo[2,3-c]pyran-2-one (where R₁, R₂, R₄═H, R₃═CH₃), 5-methyl-2H-furo[2,3-c]pyran-2-one (where R₁, R₂, R₃═H, R₄═CH₃), 3,7-dimethyl-2H-furo[2,3-c]pyran-2-one (where R₁, R₃═CH₃, R₂, R₄═H), 3,5-dimethyl-2H-furo[2,3-c]pyran-2-one (where R₁, R₄═CH₃, R₂, R₃═H), 3,5,7-trimethyl-2H-furo[2,3-c]pyran-2-one (where R₁, R₃, R₄═CH₃, R₂═H), 5-methoxymethyl-3-methyl-2H-furo[2,3-c]pyran-2-one (where R₁═CH₃, R₂, R₃═H, R₄═CH₂OCH₃), 4-bromo-3,7-dimethyl-2H-furo[2,3-c]pyran-2-one (where R₁, R₃═CH₃, R₂═Br, R₄═H), 3-methylfuro[2,3-c]pyridin-2(3H)-one (where Z═NH, R₁═CH₃, R₂, R₃, R₄═H), 3,6-dimethylfuro[2,3-c]pyridin-2(6H)-one (where Z═N—CH₃, R₁═CH₃, R₂, R₃, R₄═H). See, U.S. Pat. No. 7,576,213. These molecules are also known as karrikins. See, Halford, “Smoke Signals,” in Chem. Eng. News (Apr. 12, 2010), at pages 37-38 (reporting that karrikins or butenolides which are contained in smoke act as growth stimulants and spur seed germination after a forest fire, and can invigorate seeds such as corn, tomatoes, lettuce and onions that had been stored). These molecules are the subject of U.S. Pat. No. 7,576,213.

Beneficial Microorganism(s):

In an embodiment, the compositions described herein may comprise one or more beneficial microorganisms. The one or more beneficial microorganisms may be in a spore form, a vegetative form, or a combination thereof. The one or more beneficial microorganisms may include any number of microorganisms having one or more beneficial properties (e.g., produce one or more of the plant signal molecules described herein, enhance nutrient and water uptake, promote and/or enhance nitrogen fixation, enhance growth, enhance seed germination, enhance seedling emergence, break the dormancy or quiescence of a plant, etc.).

In one embodiment, the beneficial microorganism(s) comprise one or more bacteria. In another embodiment the bacteria are diazotrophs (i.e., bacteria which are symbiotic nitrogen-fixing bacteria). In still another embodiment, the bacteria are bacteria from the genera Rhizobium spp. (e.g., R. cellulosilyticum, R. daejeonense, R. etli, R. galegae, R. gallicum, R. giardinii, R. hainanense, R. huautlense, R. indigoferae, R. leguminosarum, R. loessense, R. lupini, R. lusitanum, R. meliloti, R. mongolense, R. miluonense, R. sullae, R. tropici, R. undicola, and/or R. yanglingense), Bradyrhizobium spp. (e.g., B. bete, B. canariense, B. elkanii, B. iriomotense, B. japonicum, B. jicamae, B. liaoningense, B. pachyrhizi, and/or B. yuanmingense), Azorhizobium spp. (e.g., A. caulinodans and/or A. doebereinerae), Sinorhizobium spp. (e.g., S. abri, S. adhaerens, S. americanum, S. aboris, S. fredii, S. indiaense, S. kostiense, S. kummerowiae, S. medicae, S. meliloti, S. mexicanus, S. morelense, S. saheli, S. terangae, and/or S. xinjiangense), Mesorhizobium spp., (M. albiziae, M. amorphae, M. chacoense, M. ciceri, M. huakuii, M. loti, M. mediterraneum, M. pluifarium, M. septentrionale, M. temperatum, and/or M. tianshanense), and combinations thereof. In a particular embodiment, the beneficial microorganism is selected from the group consisting of B. japonicum, R leguminosarum, R meliloti, S. meliloti, and combinations thereof. In another embodiment, the beneficial microorganism is B. japonicum. In another embodiment, the beneficial microorganism is R leguminosarum. In another embodiment, the beneficial microorganism is R meliloti. In another embodiment, the beneficial microorganism is S. meliloti.

In another embodiment, the one or more beneficial microorganisms comprise one or more phosphate solubilizing microorganisms. Phosphate solubilizing microorganisms include fungal and bacterial strains. In an embodiment, the phosphate solubilizing microorganism includes species from a genus selected from the group consisting of Acinetobacter spp. (e.g., Acinetobacter calcoaceticus, etc.), Arthrobacter spp, Arthrobotrys spp. (e.g., Arthrobotrys oligospora, etc.), Aspergillus spp. (e.g., Aspergillus niger, etc.), Azospirillum spp. (e.g., Azospirillum halopraeferans, etc.), Bacillus spp. (e.g., Bacillus amyloliquefaciens, Bacillus atrophaeus, Bacillus circulans, Bacillus licheniformis, Bacillus subtilis, etc.), Burkholderia spp. (e.g., Burkholderia cepacia, Burkholderia vietnamiensis, etc.), Candida spp. (e.g., Candida krissii, etc.), Chryseomonas spp. (e.g., Chryseomonas luteola, etc.), Enterobacter spp. (e.g., Enterobacter aerogenes, Enterobacter asburiae, Enterobacter spp., Enterobacter taylorae, etc.), Eupenicillium spp. (e.g., Eupenicillium parvum, etc.), Exiguobacterium spp., Klebsiella spp., Kluyvera spp. (e.g., Kluyvera cryocrescens, etc.), Microbacterium spp., Mucor spp. (e.g., Mucor ramosissimus, etc.), Paecilomyces spp. (e.g., Paecilomyces hepialid, Paecilomyces marquandii, etc.), Paenibacillus spp. (e.g., Paenibacillus macerans, Paenibacillus mucilaginosus, etc.), Penicillium spp. (e.g., Penicillium bilaiae (formerly known as Penicillium bilaii), Penicillium albidum, Penicillium aurantiogriseum, Penicillium chrysogenum, Penicillium citreonigrum, Penicillium citrinum, Penicillium digitatum, Penicillium frequentas, Penicillium fuscum, Penicillium gaestrivorus, Penicillium glabrum, Penicillium griseofulvum, Penicillium implicatum, Penicillium janthinellum, Penicillium lilacinum, Penicillium minioluteum, Penicillium montanense, Penicillium nigricans, Penicillium oxalicum, Penicillium pinetorum, Penicillium pinophilum, Penicillium purpurogenum, Penicillium radicans, Penicillium radicum, Penicillium raistrickii, Penicillium rugulosum, Penicillium simplicissimum, Penicillium solitum, Penicillium variabile, Penicillium velutinum, Penicillium viridicatum, Penicillium glaucum, Penicillium fussiporus, and Penicillium expansum, etc.), Pseudomonas spp. (e.g., Pseudomonas corrugate, Pseudomonas fluorescens, Pseudomonas lutea, Pseudomonas poae, Pseudomonas putida, Pseudomonas stutzeri, Pseudomonas trivialis, etc.), Serratia spp. (e.g., Serratia marcescens, etc.), Stenotrophomonas spp. (e.g., Stenotrophomonas maltophilia, etc.), Streptomyces spp., Streptosporangium spp., Swaminathania spp. (e.g., Swaminathania salitolerans, etc.), Thiobacillus spp. (e.g., Thiobacillus ferrooxidans, etc.), Torulospora spp. (e.g., Torulospora globose, etc.), Vibrio spp. (e.g., Vibrio proteolyticus, etc.), Xanthobacter spp. (e.g., Xanthobacter agilis, etc.), Xanthomonas spp. (e.g., Xanthomonas campestris, etc.), and combinations thereof.

In a particular embodiment, the one or more phosphate solubilizing microorganisms is a strain of the fungus Penicillium. In another embodiment, the one or more Penicillium species is P. bilaiae, P. gaestrivorus, or combinations thereof.

In another embodiment the beneficial microorganism is one or more mycorrhiza. In particular, the one or more mycorrhiza is an endomycorrhiza (also called vesicular arbuscular mycorrhizas, VAMs, arbuscular mycorrhizas, or AMs), an ectomycorrhiza, or a combination thereof.

In one embodiment, the one or more mycorrhiza is an endomycorrhiza of the phylum Glomeromycota and genera Glomus and Gigaspora. In still a further embodiment, the endomycorrhiza is a strain of Glomus aggregatum, Glomus brasilianum, Glomus clarum, Glomus deserticola, Glomus etunicatum, Glomus fasciculatum, Glomus intraradices, Glomus monosporum, or Glomus mosseae, Gigaspora margarita, or a combination thereof.

In another embodiment, the one or more mycorrhiza is an ectomycorrhiza of the phylum Basidiomycota, Ascomycota, and Zygomycota. In still yet another embodiment, the ectomycorrhiza is a strain of Laccaria bicolor, Laccaria laccata, Pisolithus tinctorius, Rhizopogon amylopogon, Rhizopogon fulvigleba, Rhizopogon luteolus, Rhizopogon villosuli, Scleroderma cepa, Scleroderma citrinum, or a combination thereof.

In still another embodiment, the one or more mycorrhiza is an ecroid mycorrhiza, an arbutoid mycorrhiza, or a monotropoid mycorrhiza. Arbuscular and ectomycorrhizas form ericoid mycorrhiza with many plants belonging to the order Ericales, while some Ericales form arbutoid and monotropoid mycorrhizas. All orchids are mycoheterotrophic at some stage during their lifecycle and form orchid mycorrhizas with a range of basidiomycete fungi. In one embodiment, the mycorrhiza may be an ericoid mycorrhiza, preferably of the phylum Ascomycota, such as Hymenoscyphous ericae or Oidiodendron sp. In another embodiment, the mycorrhiza also may be an arbutoid mycorrhiza, preferably of the phylum Basidiomycota. In yet another embodiment, the mycorrhiza may be a monotripoid mycorrhiza, preferably of the phylum Basidiomycota. In still yet another embodiment, the mycorrhiza may be an orchid mycorrhiza, preferably of the genus Rhizoctonia.

Micronutrient(s):

In still another embodiment, the compositions described herein may comprise one or more beneficial micronutrients. Non-limiting examples of micronutrients for use in the compositions described herein include vitamins, (e.g., vitamin A, vitamin B complex (i.e., vitamin B₁, vitamin B₂, vitamin B₃, vitamin B₅, vitamin B₆, vitamin B₇, vitamin B₈, vitamin B₉, vitamin B₁₂, choline) vitamin C, vitamin D, vitamin E, vitamin K, carotenoids (α-carotene, β-carotene, cryptoxanthin, lutein, lycopene, zeaxanthin, etc.), macrominerals (e.g., phosphorous, calcium, magnesium, potassium, sodium, iron, etc.), trace minerals (e.g., boron, cobalt, chloride, chromium, copper, fluoride, iodine, iron, manganese, molybdenum, selenium, zinc, etc.), organic acids (e.g., acetic acid, citric acid, lactic acid, malic aclid, taurine, etc.), and combinations thereof. In a particular embodiment, the compositions may comprise phosphorous, boron, chlorine, copper, iron, manganese, molybdenum, zinc or combinations thereof.

In certain embodiments, where the compositions described herein may comprise phosphorous, it is envisioned that any suitable source of phosphorous may be provided. In one embodiment, the phosphorus may be derived from a source. In another embodiment, suitable sources of phosphorous include phosphorous sources capable of solubilization by one or more microorganisms (e.g., Penicillium bilaiae, etc.).

In one embodiment, the phosphorus may be derived from a rock phosphate source. In another embodiment the phosphorous may be derived from fertilizers comprising one or more phosphorous sources. Commercially available manufactured phosphate fertilizers are of many types. Some common ones are those containing rock phosphate, monoammonium phosphate, diammonium phosphate, monocalcium phosphate, super phosphate, triple super phosphate, and/or ammonium polyphosphate. All of these fertilizers are produced by chemical processing of insoluble natural rock phosphates in large scale fertilizer-manufacturing facilities and the product is expensive. By means of the present invention it is possible to reduce the amount of these fertilizers applied to the soil while still maintaining the same amount of phosphorus uptake from the soil.

In still another embodiment, the phosphorous may be derived from an organic phosphorous source. In a further particular embodiment, the source of phosphorus may include an organic fertilizer. An organic fertilizer refers to a soil amendment derived from natural sources that guarantees, at least, the minimum percentages of nitrogen, phosphate, and potash. Non-limiting examples of organic fertilizers include plant and animal by-products, rock powders, seaweed, inoculants, and conditioners. These are often available at garden centers and through horticultural supply companies. In particular the organic source of phosphorus is from bone meal, meat meal, animal manure, compost, sewage sludge, or guano, or combinations thereof.

In still another embodiment, the phosphorous may be derived from a combination of phosphorous sources including, but not limited to, rock phosphate, fertilizers comprising one or more phosphorous sources (e.g., monoammonium phosphate, diammonium phosphate, monocalcium phosphate, super phosphate, triple super phosphate, ammonium polyphosphate, etc.) one or more organic phosphorous sources, and combinations thereof.

Biostimulant(s):

In one embodiment, the compositions described herein may comprise one or more beneficial biostimulants. Biostimulants may enhance metabolic or physiological processes such as respiration, photosynthesis, nucleic acid uptake, ion uptake, nutrient delivery, or a combination thereof. Non-limiting examples of biostimulants include seaweed extracts (e.g., ascophyllum nodosum), humic acids (e.g., potassium humate), fulvic acids, myo-inositol, glycine, and combinations thereof. In another embodiment, the compositions comprise seaweed extracts, humic acids, fulvic acids, myo-inositol, glycine, and combinations thereof.

Polymer(s):

In one embodiment, the compositions described herein may further comprise one or more polymers. Non-limiting uses of polymers in the agricultural industry include agrochemical delivery, heavy metal removal, water retention and/or water delivery, and combinations thereof. Pouci, et al., Am. J. Agri. & Biol. Sci., 3(1):299-314 (2008). In one embodiment, the one or more polymers is a natural polymer (e.g., agar, starch, alginate, pectin, cellulose, etc.), a synthetic polymer, a biodegradable polymer (e.g., polycaprolactone, polylactide, poly(vinyl alcohol), etc.), or a combination thereof.

For a non-limiting list of polymers useful for the compositions described herein, see Pouci, et al., Am. J. Agri. & Biol. Sci., 3(1):299-314 (2008). In one embodiment, the compositions described herein comprise cellulose, cellulose derivatives, methylcellulose, methylcellulose derivatives, starch, agar, alginate, pectin, polyvinylpyrrolidone, and combinations thereof.

Wetting Agent(s):

In one embodiment, the compositions described herein may further comprise one or more wetting agents. Wetting agents are commonly used on soils, particularly hydrophobic soils, to improve the infiltration and/or penetration of water into a soil. The wetting agent may be an adjuvant, oil, surfactant, buffer, acidifier, or combination thereof. In an embodiment, the wetting agent is a surfactant. In an embodiment, the wetting agent is one or more nonionic surfactants, one or more anionic surfactants, or a combination thereof. In yet another embodiment, the wetting agent is one or more nonionic surfactants.

Surfactants suitable for the compositions described herein are provided in the “Surfactants” section.

Surfactant(s):

Surfactants suitable for the compositions described herein may be non-ionic surfactants (e.g., semi-polar and/or anionic and/or cationic and/or zwitterionic). The surfactants can wet and emulsify soil(s) and/or dirt(s). It is envisioned that the surfactants used in described composition have low toxicity for any microorganisms contained within the formulation. It is further envisioned that the surfactants used in the described composition have a low phytotoxicity (i.e., the degree of toxicity a substance or combination of substances has on a plant). A single surfactant or a blend of several surfactants can be used.

Anionic Surfactants

Anionic surfactants or mixtures of anionic and nonionic surfactants may also be used in the compositions. Anionic surfactants are surfactants having a hydrophilic moiety in an anionic or negatively charged state in aqueous solution. The compositions described herein may comprise one or more anionic surfactants. The anionic surfactant(s) may be either water soluble anionic surfactants, water insoluble anionic surfactants, or a combination of water soluble anionic surfactants and water insoluble anionic surfactants. Non-limiting examples of anionic surfactants include sulfonic acids, sulfuric acid esters, carboxylic acids, and salts thereof. Non-limiting examples of water soluble anionic surfactants include alkyl sulfates, alkyl ether sulfates, alkyl amido ether sulfates, alkyl aryl polyether sulfates, alkyl aryl sulfates, alkyl aryl sulfonates, monoglyceride sulfates, alkyl sulfonates, alkyl amide sulfonates, alkyl aryl sulfonates, benzene sulfonates, toluene sulfonates, xylene sulfonates, cumene sulfonates, alkyl benzene sulfonates, alkyl diphenyloxide sulfonate, alpha-olefin sulfonates, alkyl naphthalene sulfonates, paraffin sulfonates, lignin sulfonates, alkyl sulfosuccinates, ethoxylated sulfosuccinates, alkyl ether sulfosuccinates, alkylamide sulfosuccinates, alkyl sulfosuccinamate, alkyl sulfoacetates, alkyl phosphates, phosphate ester, alkyl ether phosphates, acyl sarconsinates, acyl isethionates, N-acyl taurates, N-acyl-N-alkyltaurates, alkyl carboxylates, or a combination thereof.

Nonionic Surfactants

Nonionic surfactants are surfactants having no electrical charge when dissolved or dispersed in an aqueous medium. In at least one embodiment of the composition described herein, one or more nonionic surfactants are used as they provide the desired wetting and emulsification actions and do not significantly inhibit spore stability and activity. The nonionic surfactant(s) may be either water soluble nonionic surfactants, water insoluble nonionic surfactants, or a combination of water soluble nonionic surfactants and water insoluble nonionic surfactants.

Water Insoluble Nonionic Surfactants

Non-limiting examples of water insoluble nonionic surfactants include alkyl and aryl: glycerol ethers, glycol ethers, ethanolamides, sulfoanylamides, alcohols, amides, alcohol ethoxylates, glycerol esters, glycol esters, ethoxylates of glycerol ester and glycol esters, sugar-based alkyl polyglycosides, polyoxyethylenated fatty acids, alkanolamine condensates, alkanolamides, tertiary acetylenic glycols, polyoxyethylenated mercaptans, carboxylic acid esters, polyoxyethylenated polyoxyproylene glycols, sorbitan fatty esters, or combinations thereof. Also included are EO/PO block copolymers (EO is ethylene oxide, PO is propylene oxide), EO polymers and copolymers, polyamines, and polyvinylpynolidones.

Water Soluble Nonionic Surfactants

Non-limiting examples of water soluble nonionic surfactants include sorbitan fatty acid alcohol ethoxylates and sorbitan fatty acid ester ethoxylates.

Combination of Nonionic Surfactants

In one embodiment, the compositions described herein comprise at least one or more nonionic surfactants. In one embodiment, the compositions comprise at least one water insoluble nonionic surfactant and at least one water soluble nonionic surfactant. In still another embodiment, the compositions comprise a combination of nonionic surfactants having hydrocarbon chains of substantially the same length.

Other Surfactants

In another embodiment, the compositions described herein may also comprise organosilicone surfactants, silicone-based antifoams used as surfactants in silicone-based and mineral-oil based antifoams. In yet another embodiment, the compositions described herein may also comprise alkali metal salts of fatty acids (e.g., water soluble alkali metal salts of fatty acids and/or water insoluble alkali metal salts of fatty acids).

Herbicide(s):

In one embodiment, the compositions described herein may further comprise one or more herbicides. In a particular embodiment, the herbicide may be a pre-emergent herbicide, a post-emergent herbicide, or a combination thereof.

Suitable herbicides include chemical herbicides, natural herbicides (e.g., bioherbicides, organic herbicides, etc.), or combinations thereof. Non-limiting examples of suitable herbicides include bentazon, acifluorfen, chlorimuron, lactofen, clomazone, fluazifop, glufosinate, glyphosate, sethoxydim, imazethapyr, imazamox, fomesafe, flumiclorac, imazaquin, and clethodim. Commercial products containing each of these compounds are readily available. Herbicide concentration in the composition will generally correspond to the labeled use rate for a particular herbicide.

Fungicide(s):

In one embodiment, the compositions described herein may further comprise one or more fungicides. Fungicides useful to the compositions described herein will suitably exhibit activity against a broad range of pathogens, including but not limited to Phytophthora, Rhizoctonia, Fusarium, Pythium, Phomopsis or Selerotinia and Phakopsora and combinations thereof.

Non-limiting examples of commercial fungicides which may be suitable for the compositions disclosed herein include PROTÉGÉ, RIVAL or ALLEGIANCE FL or LS (Gustafson, Plano, Tex.), WARDEN RTA (Agrilance, St. Paul, Minn.), APRON XL, APRON MAXX RTA or RFC, MAXIM 4FS or XL (Syngenta, Wilmington, Del.), CAPTAN (Arvesta, Guelph, Ontario) and PROTREAT (Nitragin Argentina, Buenos Ares, Argentina). Active ingredients in these and other commercial fungicides include, but are not limited to, fludioxonil, mefenoxam, azoxystrobin and metalaxyl. Commercial fungicides are most suitably used in accordance with the manufacturer's instructions at the recommended concentrations.

Insecticide(s):

In one embodiment, the compositions described herein may further comprise one or more insecticides. Insecticides useful to the compositions described herein will suitably exhibit activity against a broad range of insects including, but not limited to, wireworms, cutworms, grubs, corn rootworm, seed corn maggots, flea beetles, chinch bugs, aphids, leaf beetles, stink bugs, and combinations thereof.

Non-limiting examples of commercial insecticides which may be suitable for the compositions disclosed herein include CRUISER (Syngenta, Wilmington, Del.), GAUCHO and PONCHO (Gustafson, Plano, Tex.). Active ingredients in these and other commercial insecticides include thiamethoxam, clothianidin, and imidacloprid. Commercial insecticides are most suitably used in accordance with the manufacturer's instructions at the recommended concentrations.

### Methods

In another aspect, methods of using gluconolactones to increase and/or enhance plant growth are disclosed. In a particular embodiment, the method includes enhancing the growth of a plant or plant part comprising contacting a plant or plant part with one or more of the gluconolactones described herein, as well as, isomers, salts, or solvates thereof. In a particular embodiment, the contacting step includes contacting a plant or plant part with one or more of the compositions described herein. In one embodiment, the contacting step comprises contacting a plant or plant part with an effective amount of one or more of the gluconolactones described herein. In a particular embodiment, the contacting step comprises contacting a plant or plant part with one or more of the gluconolactones described herein at a concentration between 1.0 mg/L-100.0 mg/L.

The contacting step can be performed by any method known in the art (including both foliar and non-foliar applications). Non-limiting examples of contacting the plant or plant part include spraying a plant or plant part, drenching a plant or plant part, dripping on a plant or plant part, dusting a plant or plant part, and/or coating a seed. In one embodiment, the contacting step is repeated (e.g., more than once, as in the contacting step is repeated twice, three times, four times, five times, six times, seven times, eight times, nine times, ten times, etc.).

In another embodiment, the method further comprises subjecting the plant or plant part to one or more agriculturally beneficial ingredients described herein. The plant or plant parts can be subjected to the one or more agriculturally beneficial ingredients as part of a composition described herein or independently from the one or more gluconolactones described herein. In one embodiment, the plant or plant parts are subjected to the one or more agriculturally beneficial ingredients as part of a composition described herein. In another embodiment, the plant or plant parts are subjected to one or more agriculturally beneficial ingredients independently from the one or more gluconolactones described herein. In one embodiment, the step of step of subjecting the plant or plant part to one or more agriculturally beneficial ingredients occurs before, during, after, or simultaneously with the step of contacting a plant or plant part with one or more of gluconolactones described herein.

In another aspect, a method for enhancing the growth of a plant or plant part is described comprising treating a soil with one or more of the gluconolactones described herein, as well as, isomers, salts, or solvates thereof, and growing a plant or plant part in the treated soil.

In an embodiment, the treating step can be performed by any method known in the art (including both foliar and non-foliar applications). Non-limiting examples of treating the soil include spraying the soil, drenching the soil, dripping onto the soil, and/or dusting the soil. In one embodiment, the treating step is repeated (e.g., more than once, as in the treating step is repeated twice, three times, four times, five times, six times, seven times, eight times, nine times, ten times, etc.). In a particular embodiment, the treating step comprised introducing one or more of the compositions described herein to the soil.

The treating step can occur at any time during the growth of the plant or plant part. In one embodiment, the treating step occurs before the plant or plant part begins to grow. In another embodiment, the treating step occurs after the plant or plant part has started to grow.

In another embodiment, the method further comprises the step of planting a plant or plant part. The planting step can occur before, after or during the treating step. In one embodiment, the planting step occurs before the treating step. In another embodiment, the planting step occurs during the treating step (e.g., the planting step occurs simultaneously with the treating step, the planting step occurs substantially simultaneous with the treating step, etc.). In still another embodiment, the planting step occurs after the treating step.

In another embodiment, the method further comprises the step of subjecting the soil to one or more agriculturally beneficial ingredients described herein. The soil can be subjected to the one or more agriculturally beneficial ingredients as part of a composition described herein or independently from the one or more gluconolactones described herein. In one embodiment, the soil is subjected to the one or more agriculturally beneficial ingredients as part of a composition described herein. In another embodiment, the soil is subjected to one or more agriculturally beneficial ingredients independently from the one or more gluconolactones described herein. In one embodiment, the step of subjecting the soil to one or more agriculturally beneficial ingredients occurs before, during, after, or simultaneously with the treating step. In one embodiment, the step of subjecting the soil to one or more agriculturally beneficial ingredients as described herein occurs before the treating step. In another embodiment, the step of subjecting the soil to one or more agriculturally beneficial ingredients as described herein occurs during the treating step. In still another embodiment, the step of subjecting the soil to one or more agriculturally beneficial ingredients as described herein occurs after the treating step. In yet another embodiment, the step of subjecting the soil to one or more agriculturally beneficial ingredients as described herein occurs simultaneously with the treating step (e.g., treating the soil with one or more of the compositions described herein, etc.).

The methods of the present invention are applicable to both and non-leguminous plants or plant parts. In a particular embodiment the plants or plant parts are selected from the group consisting of alfalfa, rice, wheat, barley, rye, oat, cotton, canola, sunflower, peanut, corn, potato, sweet potato, bean, pea, chickpeas, lentil, chicory, lettuce, endive, cabbage, brussel sprout, beet, parsnip, turnip, cauliflower, broccoli, turnip, radish, spinach, onion, garlic, eggplant, pepper, celery, carrot, squash, pumpkin, zucchini, cucumber, apple, pear, melon, citrus, strawberry, grape, raspberry, pineapple, soybean, tobacco, tomato, sorghum, and sugarcane.

### Seed Coatings

In another aspect, seeds are coated with one or more compositions described herein.

In one embodiment, seeds may be treated with composition(s) described herein in several ways but preferably via spraying or dripping. Spray and drip treatment may be conducted by formulating compositions described herein and spraying or dripping the composition(s) onto a seed(s) via a continuous treating system (which is calibrated to apply treatment at a predefined rate in proportion to the continuous flow of seed), such as a drum-type of treater. Batch systems, in which a predetermined batch size of seed and composition(s) as described herein are delivered into a mixer, may also be employed. Systems and apparati for performing these processes are commercially available from numerous suppliers, e.g., Bayer CropScience (Gustafson).

In another embodiment, the treatment entails coating seeds. One such process involves coating the inside wall of a round container with the composition(s) described herein, adding seeds, then rotating the container to cause the seeds to contact the wall and the composition(s), a process known in the art as “container coating”. Seeds can be coated by combinations of coating methods. Soaking typically entails using liquid forms of the compositions described. For example, seeds can be soaked for about 1 minute to about 24 hours (e.g., for at least 1 min, 5 min, 10 min, 20 min, 40 min, 80 min, 3 hr, 6 hr, 12 hr, 24 hr).

The invention will now be described in terms of the following non-limiting examples. Unless indicated to the contrary, water was used as the control (indicated as “control” or “CHK”).

### EXAMPLES

The following examples are provided for illustrative purposes and are not intended to limit the scope of the invention as claimed herein. Any variations in the exemplified examples which occur to the skilled artisan are intended to fall within the scope of the present invention.

### Example 1

An experiment was performed to determine the effect of gluconolactone on corn seedling root growth parameters. Unsterilized corn seeds (Peterson Hybrid corn 98L90GTCBLL pre-treated with fungicide Acceleron) were treated with water (control) and gluconolactone solutions (1 and 10 mg/L distilled water). In a clear plastic bag (25 cm×25 cm), 100 gram seeds were treated with 500 μl water (for control). Gluconolactone treatments of 1 and 10 mg/L included 250 μl water+250 μl gluconolactone solution with vigorous shaking. Four hours after treatment, 10 seeds were plated in 150 mm×15 mm polystyrene Petri plates (Fisherband) on 5⅜″ germination paper circle (Anchor Paper Co., Saint Paul, Mn) and moistened with 12 ml distilled water. Four Petri plates were prepared per treatment as 4 replicates. Petri plates were then placed in the dark in under-counter cabinets in the lab at 24° C. for 7 days. After 7 days, seedlings were removed from the cabinets, exposed to light, and their main roots severed and measured for various root parameters with WinRhizo root scanner (Regent Instruments Inc., WinRhizo Pro 2007). For all statistical analysis, student t-test was applied using JMPv.9 statistical software. Results are provided in Table 1.

TABLE 1
Effect of gluconolactone (GL) on corn
seedling root growth parameters

| | Length | Surface area | Diameter | Volume |
|---|---|---|---|---|
| Treatment | (cm) | (cm²) | (mm) | (cm³) |
| Control | 5.989b | 1.674b | 0.869a | 0.382b |
| GL 1 mg/L | 7.108a | 2.128a | 0.940a | 0.051a |
| GL 10 mg/L | 6.282ab | 1.748ab | 0.0.883a | 0.039ab |

Mean values represented by the same letter are statistically different at 0.05 level

Results in Table 1 shows that gluconolactone at lower concentrations had a root growth promotion effect. A significant root growth enhancement was observed for 1 mg/L gluconolactone; the length, root surface area and root volume were significantly higher than control whereas, higher concentration (10 mg/L) did not show any difference in root growth parameters as compared to control.

### Example 2

An experiment was designed to evaluate if any gluconolactone concentration between 1.0-10 mg/L and below 1.0 mg/L has an optimum effect on influencing seedling root growth. Example 2 was conducted according to the protocols of Example 1. Accordingly, gluconolactone concentrations of 5.0 mg/L, 1.0 mg/L, and 0.5 mg/L, were evaluated. Results are provided in Table 2.

TABLE 2
Effect of gluconolactone (GL) concentrations
on corn seedling root growth

| Treatment | Length(cm) | Diam(mm) | Root Volume(cm3) |
|---|---|---|---|
| GL 0.5 mg/L | 6.778ab | 1.190a | 0.076a |
| GL 1.0 mg/L | 7.048a | 1.116b | 0.070ab |
| GL 5.0 mg/L | 6.054b | 1.149ab | 0.063b |

Mean values represented by the same letter are statistically different at 0.05 level

Results show that there was no significant differences between 0.5 mg/L and 1.0 mg/L responses when main root length, root diameter, and root volume were compared. When considering only root length, however, 1.0 mg/L concentration was (Example #1 and Example #2) the optimum dose. Concentration of 5.0 mg/L was the least effective.

### Example 3

The effect of gluconolactone on growth of seedlings of various crops was examined. Corn, green lentil and yellow pea seeds (100 g) were treated with 1.0 mg/L gluconolactone and control seeds were treated with distilled water according to the protocols of Example 1. After treatments, seeds were allowed to dry overnight. One day after treatment, seeds were placed in 25×150 mm glass test tubes containing 40 ml of 5% water-agar solidified medium. Seeds were placed on the surface of medium in each test tube. Test tubes were then placed in a rack and kept in the lab under diffuse light. As the treated seeds were not sterilized, sterilization of the agar medium was not maintained and the test tubes were kept uncapped. Because of the agar medium being without any sugar, the occurrence of contamination was minimal for up to 10 days. The number of seeds per treatment was 10. Results are provided in Table 3.

TABLE 3
Effect of gluconolactone on growth of seedlings of various
crops grown in water-agar medium in test tube.

| | Seedling dry weight (g) | | |
|---|---|---|---|
| Treatment | Corn | Lentil | Pea |
| Control | 0.570a | 0.060b | 0.460a |
| Gluconolactone 1 mg/L | 0.606a | 0.083a* | 0.483a |

Mean values represented by the same letter are statistically different at 0.05 level

Seedlings were harvested 10 days after planting. The average plant dry biomass for corn was non-significantly 6.3% higher, for lentil, significantly 38.3% higher and for pea, non-significantly 5.0% higher.

### Example 4

The effect of a gluconolactone and chitooligosaccharide formulation on seed germination and seedling vigor was evaluated. A greenhouse seedling emergence experiment was conducted using corn seeds (Peterson Hybrid corn 98L90GTCBLL pretreated with fungicide Acceleron). Corn seeds (100 g) were treated with water (control), 10⁻⁸ M of CO and 1 mg/L and 10 mg/L of gluconolactone according to the protocols of Example 1. The CO and gluconolactone combination mixture was prepared by adding CO and gluconolactone in an amount to have 10⁻⁸M CO and 1 mg/L and 10 mg/L gluconolactone in distilled water. Seeds were planted in plastic seedling/start trays (96 plugs) containing Fafard 3B soil mix. Four days after planting, seedling emergence was counted. Seven days after planting seedling vigor was recorded on a scale of 1-4 with 1 representing the worst seedling growth and 4 representing the best seedling growth. Results are provided in Table 4.

TABLE 4
Effect of CO and gluconolactone combinations
on corn seed germination and seedling vigor

| Treatment | % emergence | Vigor (1-5) |
|---|---|---|
| CHK | 63 | 3 |
| CO | 63 | 3 |
| 1 mg/L GL + 10⁻⁸ M CO | 89 | 3 |
| 10 mg/L GL + 10⁻⁸ M CO | 87 | 4 |

The highest seedling emergence (89%) at day 4 was recorded for the 1 mg/L gluconolactone+10⁻⁸ M CO treatment. The best seedling vigor was observed for 10 mg/L gluconolactone+10⁻⁸ M CO.

### Example 5

The effect of a gluconolactone and chitooligosaccharide formulation on corn seedling growth was evaluated. Corn seeds (100 g) were treated according to the protocols of Example 4. Treated corn seeds were grown in seed trays containing Fafard 3B soilless mix. There were 30 seedlings per treatment. Five seedlings were grouped as a replicate making for 6 replicates per treatment. Seedlings were allowed to grow for 12 days and were harvested. Seedlings were put in paper envelops dried in oven at 80° C. for 2 days. Plant dry weight was taken using a countertop balance. Results are provided in Table 5.

TABLE 5
Effect of gluconolactone plus chitooligosaccharide
formulation on corn seedling growth

| Treatments | Dry Weight (g) |
|---|---|
| Chk | 1.928 b |
| CO | 1.688 c |
| 1 mg/L Gluconolactone + 10⁻⁸ M CO | 2.27 a |
| 10 mg/L Gluconolactone + 10⁻⁸ M CO | 1.978 b |

Mean values represented by the same letter are statistically different at 0.05 level

Results showed that the 1 mg/L gluconolactone+CO 10⁻⁸ M treatment was better than the 10 mg/L gluconolactone+CO 10⁻⁸ M treatment. Plant dry weight over control (17.8%) was significant following the 1 mg/L gluconolactone+CO 10⁻⁸ M treatment.

### Example 6

The effect of CO and gluconolactone on corn seedling dry weight at 5 weeks was evaluated under open space and greenhouse conditions. Corn seeds (100 g) were treated according to the protocols of Example 4 except that the concentration of gluconolactone was 1 mg/L, the CO used for greenhouse conditions was 2×10⁻⁸ M, and the CO used for open space conditions was 10⁻⁸ M. Treated corn seeds were planted in 1 gallon pots containing Fafard 3B soilless mix.

For the open space experiment, pots were grown outside the greenhouse in open space conditions under regular sunlight. The open space experiment lasted for 5 weeks and there were 5 plants per pot and 4 pots per treatment.

The greenhouse experiment lasted for 16 days. Seedlings were grown in plastic seed trays. Plants harvested from these seed trays were grouped as 5 plants as a replicate with 5 replicates/treatment. Upon harvest, plants were dried in an oven at 80° C. for 3 days. Plants harvested 4 weeks after from gallon pots were dried in oven for 7 days. Results of the open space and greenhouse experiments are provided in Table 6.

TABLE 6
Effect of CO and gluconolactone on
corn seedling dry weight (5 wks)

| Expt. sites | Harvest date | CHK | CO | 1 mg/L GL + CO |
|---|---|---|---|---|
| Open space | At 5 wks | 9.14 b | 9.29b | 10.65a |
| Greenhouse | At 2 wks | 2.418a | 2.394a | 2.694a |

Mean values represented by the same letter are statistically different at 0.05 level

Results indicate that gluconolactone+CO had a positive plant growth effect over control. Results of the open space experiment show that there was significant plant dry weight increase (16.5%) over the control. Results of the greenhouse experiment show that there was a dry weight increase (11.4%) over the control.

### Example 7

The effect of CO and various concentrations of gluconolactone on corn was evaluated. A Petri plate seed germination experiment was conducted. Corn seeds (100 g) were treated with 2×10⁻⁸ M CO containing 10 mg/L, 100 mg/L and 500 mg/L of gluconolactone following the seed treatment protocol cited in Example 4. Control seeds were treated according to the treatment protocol of Example 1. Four hours after treatment, 10 seeds were plated in 150 mm×15 mm polystyrene Petri plates (Fisherband) on 5⅜″ germination paper circle (Anchor Paper Co., Saint Paul, Min.) moistened with 12 ml distilled water. Four Petri plates were prepared per treatment as 4 replicates. Petri plates were then placed in the dark in under-counter cabinets in lab at 24° C. for 7 days. After 7 days, seedlings were removed from the cabinets, exposed to light, and their main root length was measured according to the protocols of Example 1. Results are provided in Table 7.

TABLE 7
Effect of CO and various concentrations of gluconolactone on corn

| Treatment | Length(cm) |
|---|---|
| Chk | 10.154b |
| CO + 10 GL | 11.091a |
| CO + 100 GL | 10.234b |
| CO + 500 GL | 9.999b |

Mean values represented by the same letter are statistically different at 0.05 level

Results indicate that that 10 mg/L gluconolactone+2×10⁻⁸ M CO treatment produced the longest primary root which was a significant increase (9.22% increase at 0.1 level) over the control.

### Example 8

Cue® is a genistein/daidzein isoflavonoid product available from Novozymes Biologicals, Inc. Cue® is used as a soybean seed treatment and the effect of gluconolactone in combination with flavonoids was evaluated to see if soybean production could be enhanced. Gluconolactone was prepared with Cue®. Daidzein, another isoflavonoid, was similarly prepared with gluconolactone with daidzein having the same isoflavonoid concentration as Cue®.

About 100 g soybean seeds were treated with 1 mg/L treatment solutions of gluconolactone and 200 μl of CruiserMaxx® Beans (Syngenta) fungicide+170 μl distilled water+30 μl Cue® or daidzein. For control, a total of 200 μl water was used with 200 μl CruiserMaxx® Bean fungicide. One day after seed treatments, seeds were planted in greenhouse in 1 gallon plastic pots containing soilless mix Fafard 3B. There were 3 plants/pot and 4 pots/treatment. Soybean plants were occasionally fertilized with 20-15-20 NPK fertilizer. Pods were harvested after 6 weeks. Average pod fresh weights were analyzed by student-t test using JUMP statistical software.

TABLE 8
Effect of gluconolactone with isoflavonoids on
soybean pod yield x̅ Fresh Weight (g)

| | | Cue ® + | | Daidzein + |
|---|---|---|---|---|
| Trial # | Cue ® | Gluconolactone | Daidzein | Gluconolactone |
| 1st | 34.448 | 36.5696 | 36.782 | 37.618 |
| trial | | | | |
| 2nd | 34.886 | 38.28 | 36.4 | 36.148 |
| trial | | | | |
| 3rd | 32.272 | 32.476 | 32.482 | 33.212 |
| trial | | | | |

The results show that gluconolactone, when added to either Cue® or daidzein, produced extra pod yields over either Cue® or daidzein alone. When added with Cue®, gluconolactone produced 6, 9.7, and 0.6% yield increase over Cue® 1^{st}, 2^{nd} and 3^{rd} trials, respectively. Similarly, when added with daidzein, gluconolactone produced an approximately 2.5% yield increase in 2 out of 3 trials.

### Example 9

The effect of daidzein and gluconolactone on soybean plant growth was evaluated in a greenhouse study against Cue®. Gluconolactone combined with daidzein and tested against Cue® on three different soil types (Metro Mix, Fafard 3B, and Garden Mix soil). Seedlings were grown from treated seeds according to the protocols of Example 8 in 4″ plastic pots containing various soil media. Each pot had 2 seedlings and there were 5 pots per treatment. Plants were harvested after 18 days and their dry weights were taken from oven dried (80° C. for 3 days) samples. Results are provided in Table 9.

TABLE 9
Effect of gluconolactone + daidzein treatment compared
to Cue ® on soybean plant growth in greenhouse.

| | Metro Mix | | Fafard | | Garden Mix | |
|---|---|---|---|---|---|---|
| | Daidzein + | | Daidzein + | | Daidzein + | |
| | Gluco | Cue | Gluco | Cue | Gluco | Cue |
| Average | 1.582 | 1.446 | 1.346 | 1.314 | 0.928 | 0.826 |
| Std. | 0.084 | 0.078 | 0.109 | 0.065 | 0.027 | 0.069 |
| Error | | | | | | |
| % | 9.41 | | 2.44 | | 12.35 | |
| increase | | | | | | |

The results indicate that there was no significant difference in plant dry weights between the gluconolactone+daidzein treatment and the Cue® treatment for each individual soil type, however, the gluconolactone+daidzein treatment produced a positive dry biomass increase (9.41, 2.44 and 12.35%) as compared to the Cue® treatment alone.

### Example 10

The effect of gluconolactone on the performance of rhizobial inoculants for soybean seeds was evaluated to see if soybean production could be enhanced. 1 mg/L of gluconolactone was added to rhizobial inoculants products Cell-Tech® and Optimize-400® (both from Novozymes Biologicals Inc.). Seed treatments were performed following the instruction cited in the product labels. The total liquid dose going onto soybean seeds was maintained the same when gluconolactone was added. Control seeds were treated with water. About 100 g seed was treated in a clear plastic bag (25 cm×25 cm) with treatment solutions. Seeds were planted 2 hours after treatment in 1 g plastic pots containing Fafard soilless mix in greenhouse. 3 plants were allowed to grow per pot and there were 5 pots per treatment. Pods were harvested 6 weeks after planting.

TABLE 10
Effect of gluconolactone on the performance
of Rhizobial inoculants for soybean seeds.

| | | CT + | | |
|---|---|---|---|---|
| | Cell-Tech | Glucono- | | Optimize-400 + |
| | (CT) | lactone (GL) | Optimize-400 | GL |
| Average | 10.608 | 10.964 | 11.85 | 12.424 |
| Std. Error | 0.561 | 0.633 | 0.231 | 0.294 |
| % increase | | 3.36 | | 4.84 |

Results show that the addition of gluconolactone had a positive impact on yield increase. The addition of gluconolactone produced dry pod yield increases (3.36% and 4.84%) over either Cell-Tech® or Optimize-400® alone.

### Example 11

The effect of antioxidants on stress tolerance by lentil seedlings at 8° C. was evaluated. Lentil seeds treated with the treatment solutions at 5 ml/kg of seed. Treatment solutions were prepared as 1.0 mg/L gluconolactone, 100 mg/L glutathione, 100 mg/L phenylglucoside (PADG) and water as the control (CHK). Treated seeds were plated in large Petri plates on germination paper moistened with deionized water. Plates were incubated at 8° C. in a walk in cold room. Seven days after plating, seedling roots were measured for various growth parameters.

TABLE 11
Effect of gluconolactone and other antioxidants
on the stress tolerance of lentil seedlings.

| | Seedling | | | No. of |
|---|---|---|---|---|
| | Root Length | Surface Area | Volume | lateral |
| Treatments | (cm) | (cm²) | (cm³) | roots |
| Gluconolactone | 2.895 a | 0.9457 a | 0.02474 a | 2.935 ab |
| Glutathione | 2.631 ab | 0.88758 a | 0.024 a | 3.1765 a |
| PADG | 2.761 ab | 0.8544 a | 0.0214 a | 2.385 bc |
| CHK | 2.427 b | 0.68 b | 0.01575 b | 2.063 c |

Mean values represented by the same letter are statistically different at 0.05 level

Results showed antioxidants have a positive effect on lentil seedlings when kept at low temperatures (i.e., 8° C.). Results indicate that gluconolactone significantly increased seedling root lengths, surface area, volume, and number of lateral roots when compared to the control. Glutathione increased seedling root length over the control and significantly increased surface area, volume, and the number of lateral roots over the control. PADG increased seedling root length and number of lateral roots over the control and significantly increased surface area and volume over the control.

It will be understood that the Specification and Examples are illustrative of the present embodiments and that other embodiments within the spirit and scope of the claimed embodiments will suggest themselves to those skilled in the art. Although this invention has been described in connection with specific forms and embodiments thereof, it would be appreciated that various modifications other than those discussed above may be resorted to without departing from the spirit or scope of the invention as defined in the appended claims. For example, equivalents may be substituted for those specifically described, and in certain cases, particular applications of steps may be reversed or interposed all without departing from the spirit or scope for the invention as described in the appended claims.

1. A composition comprising:
a) an agronomically acceptable carrier; and
b) an effective amount of one or more gluconolactones or salt thereof for enhancing plant growth.

2. The composition of claim 1, wherein the composition includes one or more agriculturally beneficial ingredients.

3. The composition of claim 2, wherein the one or more agriculturally beneficial ingredients are one or more plant signal molecules selected from the group consisting of LCOs, COs, chitinous compounds, flavonoids, jasmonic acid, methyl jasmonate, linoleic acid, linolenic acid, karrikins, and combinations thereof.

4. The composition of claim 2, wherein the one or more agriculturally beneficial ingredients comprises one or more beneficial microorganisms.

5. The composition of claim 4, wherein the one or more beneficial microorganisms comprise one or more nitrogen fixing microorganisms, one or more phosphate solubilizing microorganisms, one or more mycorrhizal fungi, or combinations thereof.

6. The composition of claim 1, wherein the composition further comprises one or more micronutrients.

7. The composition of claim 5, wherein the one or more micronutrients comprise phosphorous, copper, iron, zinc, or a combination thereof.

8. The composition of claim 1, wherein the composition comprises the one or more gluconolactones or salts thereof at a concentration at of 0.5 mg/L to 500 mg/L, preferably 0.5 mg/L to 100 mg/L.

9. A method for enhancing the growth of a plant or plant part comprising contacting a plant or plant part with an effective amount of one or more gluconolactones or salts thereof.

10. The method of claim 9, wherein the method further comprises subjecting the plant or plant part to one or more agriculturally beneficial ingredients.

11. The method of claim 10, wherein the one or more agriculturally beneficial ingredients are one or more plant signal molecules selected from the group consisting of LCOs, COs, chitinous compounds, flavonoids, jasmonic acid, methyl jasmonate, linoleic acid, linolenic acid, karrikins, and combinations thereof.

12. The method of claim 10, wherein the one or more agriculturally beneficial ingredients comprises one or more beneficial microorganisms.

13. The method of claim 12, wherein the one or more beneficial microorganisms comprise one or more nitrogen fixing microorganisms, one or more phosphate solubilizing microorganisms, one or more mycorrhizal fungi, or combinations thereof.

14. The method of claim 9, wherein, the contacting step comprises contacting a plant or plant part with a composition comprising the one or more gluconolactones or salts thereof.

15. The method of claim 14, wherein the composition comprises the composition of claim 1.

16. The method of claim 9, wherein the contacting comprises contacting a seed.

17. A method for enhancing the growth of a plant or plant part comprising
a. treating a soil with an effective amount of one or more gluconolactones or salts thereof;
b. growing a plant or plant part in the treated soil.

18. The method of claim 17, wherein the treating step comprises introducing the one or more gluconolactones or salts thereof as a composition.

19. The method of claim 18, wherein the composition comprises the composition of claim 1.

20. A seed coated with a composition of claim 1.
